(19) United States
(12) Patent Application Publication
(10) Pub. No.: US 2014/0244852 A1
(43) Pub. Date: Aug. 28, 2014

(54) Method of Reducing Mutual Interference between Universal Serial Bus (USB) data transmission and wireless data transmission

(71) Applicant: Ralink Technology Corp., Hsinchu County (TW)

(72) Inventors: Cheok Yan Goh, Hsinchu City (TW); Yu-Hsun Chen, Hsinchu County (TW); Chih-Chieh Chou, Taipei City (TW); Horng-Bin Wang, Hsinchu City (TW); Ching-Hwa Yu, Tainan City (TW)

(73) Assignee: Ralink Technology Corp., Hsinchu County (TW)

(21) Appl. No.: 14/191,382

(22) Filed: Feb. 26, 2014

Related U.S. Application Data
(60) Provisional application No. 61/769,952, filed on Feb. 27, 2013.

(51) Int. Cl. H04L 29/06

(52) U.S. Cl. CPC H04L 69/08
USPC 709/230

(57) ABSTRACT

A method of reducing mutual interference between Universal Serial Bus (USB) data transmission and wireless communication for an electronic device is disclosed. The method comprises establishing a plurality of physical layer links for the USB data transmission in a plurality of supported USB modes; dynamically selecting one of the supported USB modes according to the wireless communication; and performing the USB data transmission in the selected USB mode.

### CROSS REFERENCE TO RELATED APPLICATION

This application claims the benefit of U.S. Provisional Application No. 61/769,952, filed on Feb. 27, 2013, the contents of which are incorporated herein in their entirety.

### BACKGROUND

Universal Serial Bus (USB) is a public interface standard for accessing peripheral devices and personal computers. Recently, the application of USB has been extended to a large number of consumer electronics and mobile devices, Interfaces complying with the specification of the USB 2.0 have now been enjoying wide application, since the USB 2.0 interface has a highest speed of 480 Mb/S and also the capability of power supply, which leads to the popularity of the USB 2.0 interface in the current field of PC interface. As storage capacity and network speed enters the epoch of Gigabyte, however, the data connection between a computer and peripheral devices requires a higher transmission rate, and USB 2.0 is having difficulty in meeting the continuous growing requirement of access rate.

In order to meet the demands for higher data transmission, a USB 3.0 already made her debut in November, 2008. The USB 3.0 promises 4.8 Gbps “Super Speed” data transfers and its raw throughput can reaches 4 Gbps. When operating in “Super Speed”, the USB 3.0 adopts “full duplex” signaling over two differential pairs separating from non-super speed differential pairs. As a result, USB 3.0 cables contain 2 wires for power and ground, 2 wires for non-Super Speed data, and 4 wires for Super Speed data, and a shield. In contrast, the USB 2.0 cables contain a transmission pair for data. Apart from that, Super Speed establishes a communications pipe between the host and each device, in a host-directed protocol. But USB 2.0 broadcasts packet traffic to all devices. Certainly, the USB 3.0 has many features different than the USB 2.0 and those differences are well known by those skilled in the art, and thus not elaborated on herein.

A USB3.0 system coexist a USB 2.0 interface and a USB 3.0 interface. When the device is identified, the USB 3.0 system decides whether to run in super speed (SS) or high speed (HS). However, when the USB 3.0 system is running in super speed, the noise from USB 3.0 data spectrum (in the 2.4-2.5 GHz range) interferes with the wireless signals such the IEEE 802.11b/g/n or Bluetooth, or they may use proprietary protocols. Therefore, the wireless data transmission is affected by the USB 3.0 data transmission. This may result in a drop in throughput on the wireless link.

### SUMMARY

It is therefore an objective of the present disclosure to provide a method of reducing mutual interference between Universal Serial Bus (USB) data transmission and wireless data transmission for an electronic device.

A method of reducing mutual interference between Universal Serial Bus (USB) data transmission and wireless data transmission for an electronic device is disclosed. The method comprises establishing a plurality of physical layer links for the USB data transmission in a plurality of USB modes when the plurality of USB mode are supported, each of the physical layer links corresponding to one of the USB modes; dynamically selecting one of the USB modes according to the wireless data transmission; and performing the USB data transmission in the selected USB mode.

An electronic device is disclosed. The electronic device comprises a plurality of USB physical layers, a wireless communication module and a USB controller. The plurality of USB physical layers is used for establishing a plurality of physical layer links for USB data transmission in a plurality of USB modes. Each of the physical layer links corresponds to one of the USB modes. The wireless communication module is used for performing wireless data transmission. The USB controller is used for dynamically selecting one of the USB modes according to wireless data transmission and performing the USB data transmission in the selected USB mode.

An electronic device is disclosed. The electronic device comprises a plurality of hubs, a wireless communication module and a USB controller. The plurality of hubs is used for establishing a plurality of physical layer links for USB data transmission in a plurality of USB modes. Each of the physical layer links corresponds to one of the USB modes. The wireless communication module is used for performing wireless data transmission. The USB controller is used for dynamically selecting one of the USB modes according to wireless data transmission and performing the USB data transmission in the selected USB mode.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flow chart of an exemplary process.

FIG. 2 is an exemplary electronic device.

FIG. 3 is an exemplary electronic device.

### DETAILED DESCRIPTION

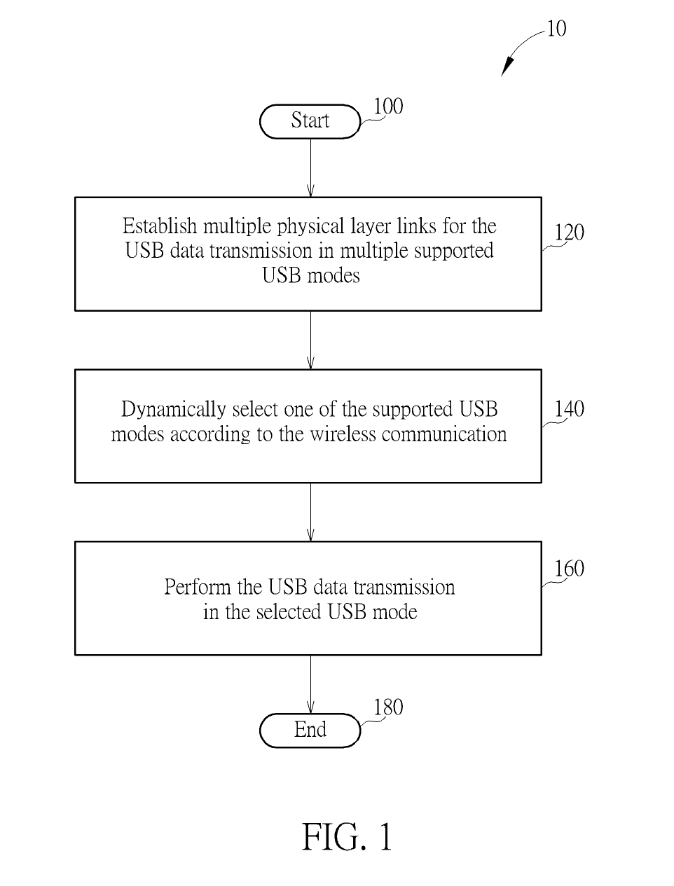

Please refer to FIG. 1, which is a flow chart of an exemplary process 10. The exemplary process 10 is used for reducing mutual interference between Universal Serial Bus (USB) data transmission and wireless communication for an electronic device. The electronic device includes a USB controller and a wireless communication module. The USB controller is used for performing the USB data transmission. The wireless communication module is used for performing the wireless communication. The process 10 includes the following steps:

Step 100: Start.

Step 120: Establish multiple physical layer links for the USB data transmission in multiple supported USB modes.

Step 140: Dynamically select one of the supported USB modes according to the wireless communication.

Step 160: Perform the USB data transmission in the selected USB mode.

Step 180: End.

According to the process 10, the multiple physical layer links for the multiple supported USB modes are established. The supported USB modes include a USB 3.0 mode operating in super speed and a USB 2.0 mode operating in high speed, but not limited herein. Each of the physical layer links corresponds to one of the supported USB modes. The electronic device may attempt to establish the physical layer link for the USB 3.0 mode first and then attempt to establish a physical layer link for the USB 2.0 mode. If the USB 3.0 mode and USB 2.0 both are supported, both of physical layer links are established. Then, one of the supported USB modes for the USB data transmission is dynamically selected according to the wireless communication. For example, the USB 3.0 mode is selected when the wireless communication is performed according to IEEE 802.11ac standard or when no wireless data transmission is performed. For another example, the USB 2.0 mode is selected when the wireless communication is performed according to IEEE 802.11b, 802.11g, 802.11n standard or a Bluetooth standard. Since the wireless communication complied with IEEE 802.11ac operates in a bandwidth of 5 GHz, the USB data transmission in the USB 3.0 mode does not interfere with the wireless communication and still has enough throughputs. Likewise, the USB data transmission in the USB 2.0 mode does not interfere with the wireless communication operating in a bandwidth of 2.4 GHz. Therefore, the example of the present disclosure can avoid the mutual interference between the USB data transmission and the wireless communication and also retain enough throughputs. Please note that if the electronic fails to establish the physical layer link for USB 3.0, the USB data transmission will be performed in the USB 2.0 mode.

In addition, the process 10 can include other steps when the wireless communication includes data packets from different wireless protocols, in order to know which wireless protocol is used in the received data packets. The process 10 includes a step of receiving a sending signal bgn_sending from the wireless communication module when the electronic device works as an access point (i.e. the USB controller operates in a host mode). The sending signal bgn_sending indicates the wireless protocol used in the wireless communication. Or, the process 10 includes another step of performing a polling procedure through a high speed protocol to obtain the sending signal bgn_sending from the wireless communication module when the electronic device works as a network interface controller (NIC) or a network interface card (i.e. the USB controller operates in a device mode). In addition, the USB controller can send a signal hs_sending to the wireless communication module to inform the wireless communication module which USB mode is used. The signal hs_sending indicates which USB mode is used in the USB data transmission. With USB mode information, the wireless communication module can wait until the USB data transmission is finished, thereby avoiding the mutual interference.

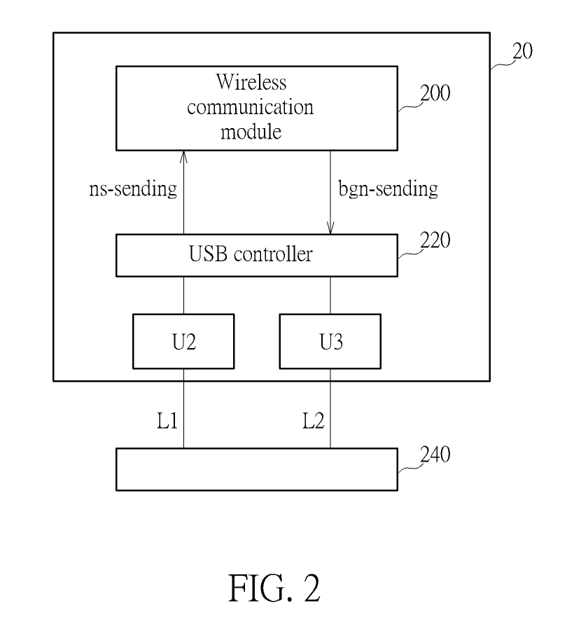

Please refer to FIG. 2, which is an exemplary electronic device 20. The electronic device 20 includes physical layers U2 and U3 and a wireless communication module 200 and a USB controller 220. The physical layer U2 and the physical layer U3 are used for establishing physical layer links L1 and L2 for USB2.0 data transmission and USB 3.0 data transmission, respectively, with another electronic device 240. If the USB controller 220 works as a host (e.g. the electronic device 20 is an access point), the electronic device 240 could be a USB flash drive, but not limited herein. If the USB controller 220 works as a device (e.g. the electronic device 20 is a network interface controller (NIC) or a network interface card), the electronic device 240 could be a computer or a laptop, but not limited herein. The wireless communication module 200 is used for performing wireless communication. The wireless communication can be complied with different wireless protocols, such as IEEE 802.11ac, IEEE 802.11b, 802.11g, 802.11n standard or a Bluetooth standard. The USB controller 220 is used for dynamically selecting the USB 2.0 mode or the USB 3.0 mode to perform the USB data transmission according to the wireless communication. When the wireless communication complied with IEEE 802.11ac occurs, the USB controller 220 selects the USB 3.0 mode to perform the USB data transmission through the physical layer U3. When the wireless communication complied with IEEE 802.11b, 802.11g, 802.11n standard or a Bluetooth standard occurs, the USB controller 220 selects the USB 2.0 mode to perform the USB data transmission through the physical layer U2. In this situation, the mutual interference between the USB data transmission and the wireless data transmission can be avoided.

When the wireless communication includes data packets from different wireless protocols, the USB controller 220 receives a sending signal bgn_sending from the wireless communication module 200 if the USB controller 220 operates in a host mode (e.g. the electronic device 20 is an access point). The sending signal bgn_sending indicates the wireless protocol used in the wireless communication. If the USB controller 220 operates in a device mode (e.g. the electronic device 20 is a network interface controller (NIC) or a network interface card), the USB controller 220 performs a polling procedure through a high speed protocol to obtain the sending signal bgn_sending from the wireless communication module 200. In this situation, the USB controller 220 can know which wireless protocol is used in the wireless communication. In addition, the USB controller 220 can send a signal hs_sending to the wireless communication module 200 to inform the wireless communication module 220 which USB mode is used by the USB controller 220. The signal hs_sending indicates which USB mode is used in the USB data transmission. With USB mode information, the wireless communication module 200 can wait until the USB data transmission is finished, thereby avoiding the mutual interference.

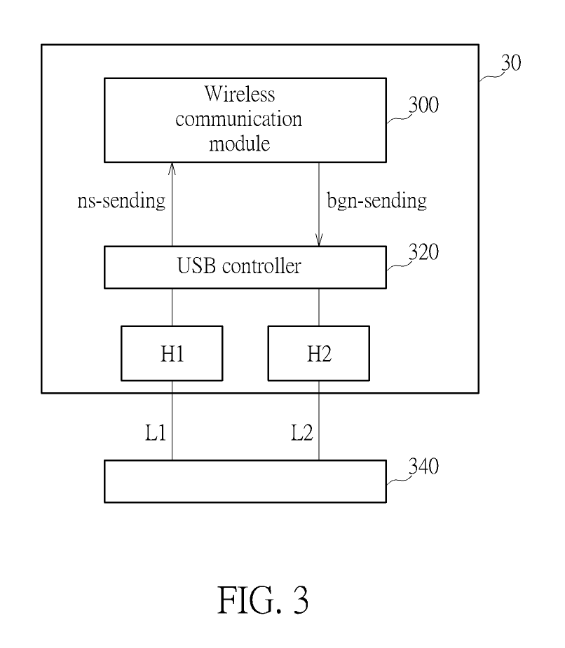

Please refer to FIG. 3, which is an exemplary electronic device 30. The electronic device 30 includes hub H1 and hub H2 and a wireless communication module 300 and a USB controller 320. The hub H1 and the hub H2 are used for establishing physical layer links L1 and L2 for USB2.0 data transmission and USB 3.0 data transmission, respectively, with another electronic device 340. If the USB controller 320 works as a host (e.g. the electronic device 30 is an access point), the electronic device 340 could be a USB flash drive, but not limited herein. If the USB controller 320 works as a device (e.g. the electronic device 30 is a network interface controller (NIC) or a network interface card), the electronic device 340 could be a computer or a laptop, but not limited herein. The wireless communication module 300 is used for performing wireless communication. The wireless communication can be complied with different wireless protocols, such as IEEE 802.11ac, IEEE 802.11b, 802.11g, 802.11n standard or a Bluetooth standard. The USB controller 320 is used for dynamically selecting the USB 2.0 mode or the USB 3.0 mode according to the wireless communication to perform the USB data transmission. When the wireless communication complied with IEEE 802.11ac occurs, the USB controller 320 selects the USB 3.0 mode to perform the USB data transmission through the hub H2. When the wireless communication complied with IEEE 802.11b, 802.11g, 802.11n standard or a Bluetooth standard occurs, the USB controller 320 selects the USB 2.0 mode to perform the USB data transmission through the hub H1. In this situation, the mutual interference between the USB data transmission and the wireless data transmission can be avoided.

When the wireless communication includes data packets from different wireless protocols, the USB controller 320 receives a sending signal bgn_sending from the wireless communication module 300 if the USB controller 320 operates in a host mode (e.g. the electronic device 30 is an access point). The sending signal bgn_sending indicates the wireless protocol used in the wireless data transmission. If the USB controller 320 operates in a device mode (e.g. the electronic device 30 is a network interface controller (NIC) or a network interface card), the USB controller 320 performs a polling procedure through a high speed protocol to obtain the sending signal bgn_sending from the wireless communication module 300. In this situation, the USB controller 320 can know which wireless protocol is used in the wireless communication. In addition, the USB controller 320 can send a signal hs_sending to the wireless communication module 300 to inform the wireless communication module 320 which USB mode is used by the USB controller 320. The signal hs_sending indicates which USB mode is used in the USB data transmission. With USB mode information, the wireless communication module 300 can wait until the USB data transmission is finished, thereby avoiding the mutual interference.

To sum up, the examples of the present disclosure establish two physical layer links for both of the USB 3.0 mode and the USB 2.0 mode. Then the USB 3.0 mode or the USB 2.0 mode is dynamically selected according to the wireless protocol to perform the USB data transmission. When the wireless data transmission complied with IEEE 802.11ac is performed, the USB data transmission is performed in the USB 3.0 mode. When the wireless communication complied with IEEE 802.11b, 802.11g, 802.11n standard or a Bluetooth standard is performed, the USB data transmission is performed in the USB 2.0 mode. Therefore, the mutual interference between the USB data transmission and the wireless data transmission can be avoided.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of reducing mutual interference between Universal Serial Bus (USB) data transmission and wireless communication for an electronic device, the method comprising:
establishing a plurality of physical layer links for the USB data transmission in a plurality of supported USB modes ;
dynamically selecting one of the supported USB modes according to the wireless communication; and
performing the USB data transmission in the selected USB mode.

2. The method of claim 1, wherein dynamically selecting one of the supported USB modes according to the wireless data transmission comprises:
selecting a first USB mode when the wireless communication is performed according to a first wireless protocol or when no wireless data transmission is performed; and
selecting a second USB mode when the wireless communication is performed according to a second wireless protocol,
wherein the first USB mode has a faster data rate than the second USB mode and the first wireless protocol uses a different bandwidth than the second wireless protocol.

3. The method of claim 2, wherein the first USB mode is USB 3.0 mode while the first wireless protocol is IEEE 802.11ac standard and the second USB mode is USB 2.0 mode while the second wireless protocol is IEEE 802.11b, 802.11g, 802.11n standard or a Bluetooth standard.

4. The method of claim 1, wherein the step of establishing physical layer links in the plurality of supported USB modes comprises:
establishing the physical layer links with a host device through a plurality of physical layers, wherein each of the physical layers corresponds to one of the supported USB modes.

5. The method of claim 1, wherein the step of establishing physical layer links in the plurality of supported USB modes comprises:
establishing the physical layer links with a host device through a plurality of hubs, wherein each of the hubs corresponds to one of the supported USB modes.

6. The method of claim 1 further comprising:
receiving a first signal from a wireless communication module, wherein the first signal indicates which wireless protocol is used in the wireless communication.

7. The method of claim 1 further comprising:
performing a polling procedure to obtain a first signal from a wireless communication module, wherein the first signal indicates a wireless protocol used in the wireless communication.

8. The method of claim 1 further comprising:
sending a second signal to a wireless communication module, wherein the second signal indicates which USB mode is used in the USB data transmission.

9. An electronic device comprising:
a plurality of USB physical layers for establishing a plurality of physical layer links for USB data transmission in a plurality of supported USB modes, each of the physical layer links corresponding to one of the USB modes;
a wireless communication module for performing wireless communication; and
a USB controller for dynamically selecting one of the supported USB modes according to wireless communication and performing the USB data transmission in the selected USB mode.

10. The electronic device of claim 9, wherein the USB controller selects a first USB mode when the wireless communication is performed according to a first wireless protocol or when no wireless data transmission is performed and selects a second USB mode when the wireless communication is performed according to a second wireless protocol, wherein the first USB mode has a faster data rate than the second USB mode and the first wireless protocol uses a different bandwidth than the second wireless protocol.

11. The electronic device of claim 10, wherein the first USB mode is USB 3.0 mode while the first wireless protocol is IEEE 802.11ac standard and the second USB mode is USB 2.0 mode while the second wireless protocol is IEEE 802.11b, 802.11g, 802.11n standard or a Bluetooth standard.

12. The electronic device of claim 9, wherein the USB controller further receives a first signal from the wireless communication module, wherein the first signal indicates a wireless protocol used in the wireless communication.

13. The electronic device of claim 9, wherein the USB controller further performs a polling procedure to obtain a first signal from the wireless communication module, wherein the first signal indicates a wireless protocol used in the wireless communication.

14. The electronic device of claim 9, wherein the USB controller sends a second signal to a wireless communication module, wherein the second signal indicates which USB mode is used in the USB data transmission.

15. An electronic device comprising:
a plurality of hubs for establishing a plurality of physical layer links for USB data transmission in a plurality of supported USB modes, each of the physical layer links corresponding to one of the USB modes;
a wireless communication module for performing wireless communication; and
a USB controller for dynamically selecting one of the supported USB modes according to wireless communication and performing the USB data transmission in the selected USB mode.

16. The electronic device of claim 15, wherein the controller selects a first USB mode when the wireless communication is performed according to a first wireless protocol or when no wireless data transmission is performed and selects a second USB mode when the wireless communication is performed according to a second wireless protocol, wherein the first USB mode has a faster data rate than the second USB mode and the first wireless protocol standard uses a different bandwidth than the second wireless protocol.

17. The electronic device of claim 16, wherein the first USB mode is USB 3.0 mode while the first wireless protocol is IEEE 802.11ac standard and the second USB mode is USB 2.0 mode while the second wireless protocol is IEEE 802.11b, 802.11g, 802.11n standard or a Bluetooth standard.

18. The electronic device of claim 15, wherein the controller further receives a first signal from the wireless communication module, wherein the first signal indicates a wireless protocol used in the wireless communication.

19. The electronic device of claim 15, wherein the USB controller further performs a polling procedure to obtain a first signal from the wireless communication module, wherein the first signal indicates a wireless protocol used in the wireless communication.

20. The electronic device of claim 15, wherein the USB controller sends a second signal to a wireless communication module, wherein the second signal indicates which USB mode is used in the USB data transmission.
